(19) United States
(12) Patent Application Publication
(10) Pub. No.: US 2016/0171617 A1
(43) Pub. Date: Jun. 16, 2016

(54) GENERATING REAL-TIME INSURANCE ALERTS FROM A MOBILE DEVICE

(71) Applicant: International Business Machines Corporation, Armonk, NY (US)

(72) Inventors: Bhavani K. Eshwar, Bangalore (IN); Rajeev Gupta, Noida (IN); Mukesh K. Mohania, New Delhi (IN); Shyam K. Yerramsetti, Telangana (IN)

(21) Appl. No.: 14/570,776

(22) Filed: Dec. 15, 2014

(51) Int. Cl. G06Q 40/08

(52) U.S. Cl. CPC G06Q 40/08

(57) ABSTRACT

A tool for generating real-time insurance alerts on a mobile device. The tool registers, by one or more computer processors, for an insurance policy. The tool receives, by one more computer processors, an alert template for the insurance policy, wherein the alert template includes at least one alert condition. The tool collects, by one or more computer processors, data relative to the at least one alert condition. The tool determines, by one or more computer processors, whether the at least one alert condition is satisfied.

### BACKGROUND OF THE INVENTION

The present invention relates generally to information management and more particularly to monitoring and generating real time micro insurance alerts using a mobile device.

In growth markets, up to thirty-five percent of drivers of four wheel vehicles and seventy percent of riders of motorcycles are uninsured. Typically, drivers are uninsured because of high insurance premiums which have to be paid independent of mileage driven, driving behavior, and historical data, etc. In current insurance solutions, a driver has the option to purchase time based insurance (e.g., annual) or pay-as-you-go insurance where the driver's insurance premium is calculated on a per use basis. Pay-as-you-go insurance solutions collect various data, such as how a vehicle is driven, how much a vehicle is driven, and when a vehicle is being driven, for use in calculating an insurance quote. The various data is collected in a telemetric (e.g., black-box) recording device integrated into a vehicle that exchanges information with a server. The growth markets may not have the infrastructure to support frequent exchange of information between telemetric devices in vehicles and insurance servers to support real-time alert generation.

### SUMMARY

Aspects of an embodiment of the present invention disclose a method, system, and computer program product for generating real-time insurance alerts on a mobile device. The method includes registering, by one or more computer processors, for an insurance policy. The method includes receiving, by one more computer processors, an alert template for the insurance policy, wherein the alert template includes at least one alert condition. The method includes collecting, by one or more computer processors, data relative to the at least one alert condition. The method includes determining, by one or more computer processors, whether the at least one alert condition is satisfied.

### BRIEF DESCRIPTION OF THE DRAWINGS

FIG. 1 is a functional block diagram illustrating a data processing environment, generally designated 100, in accordance with an embodiment of the present invention.

FIG. 2 depicts a flowchart of an exemplary process flow, generally designated 200, for generating real-time insurance alerts, in accordance with an embodiment of the present invention.

FIG. 3 depicts a block diagram depicting components of a data processing system (such as the mobile device of FIG. 1), generally designated 300, in accordance with an embodiment of the present invention.

### DETAILED DESCRIPTION

Embodiments of the present invention recognize that in growth markets, such as India and China, drivers typically do not buy insurance because of its rigid structure (i.e., a driver must buy insurance for a whole year irrespective of whether the driver is actually driving a vehicle or not for the whole year). Embodiments of the present invention further recognize that it is desirable to have scalability with respect to a number of users while having scarcity of resources (e.g., coverage and bandwidth).

Embodiments of the present invention provide the capability to provide insurance related alerts to a user while minimizing the need for real-time communication between, for example, the user and a server. Embodiments of the present invention further provide the capability to divide an insurance premium calculation into two components in real-time: an offline calculation and an online (real-time) calculation. Embodiments of the present invention further provide the capability to generate insurance alerts in real-time by utilizing alert templates for calculating modified insurance premiums based on real-time and historical metrics.

Implementation of such embodiments may take a variety of forms, and exemplary implementation details are discussed subsequently with reference to the Figures.

As will be appreciated by one skilled in the art, aspects of the present invention may be embodied as a method or system. Accordingly, aspects of the present invention may take the form of an entirely hardware embodiment, an entirely software embodiment (including firmware, resident software, micro-code, etc.), or an embodiment combining software and hardware aspects that may all generally be referred to herein as a “circuit,” “module,” or “system.” Furthermore, aspects of the present invention may take the form of a computer program product embodied in one or more computer-readable media having computer readable program code/instructions embodied thereon.

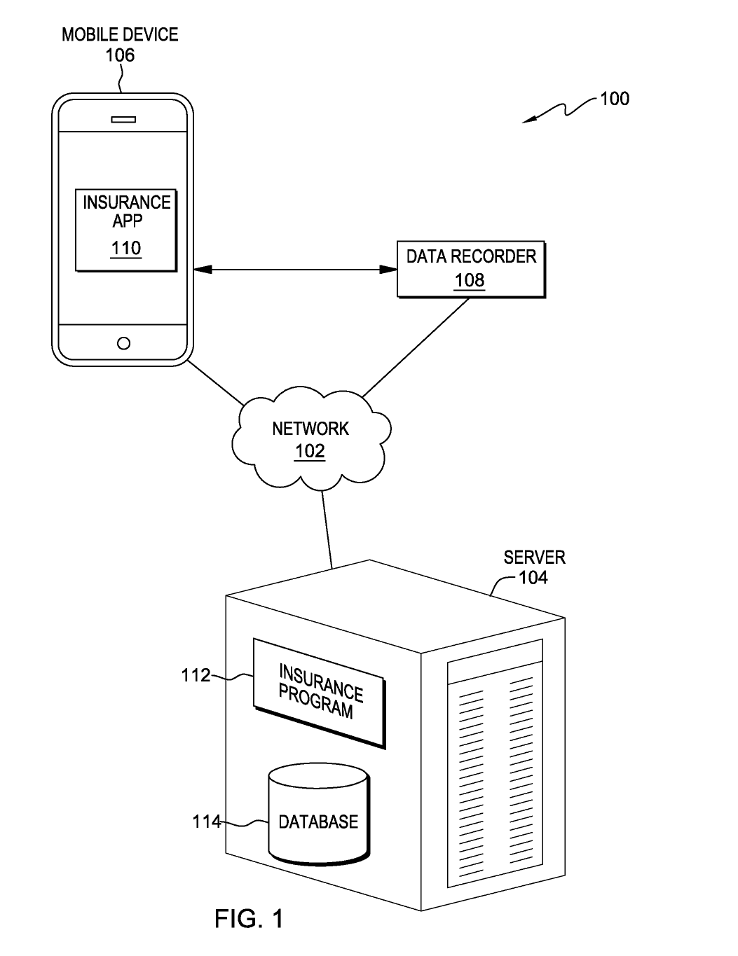

The present invention will now be described in detail with reference to the Figures. FIG. 1 provides only an illustration of one implementation and does not imply any limitations with regard to the environments in which different embodiments may be implemented. Many modifications to the depicted environment may be made by those skilled in the art without departing from the scope of the invention as recited by the claims. FIG. 1 illustrates an exemplary data processing environment 100 including a network 102, a server 104, a mobile device 106, and a data recorder 108.

In the exemplary embodiment, network 102 is the Internet representing a worldwide collection of networks and gateways that use TCP/IP protocols to communicate with one another. Network 102 may include wire cables, wireless communication links, fiber optic cables, routers, switches and/or firewalls. Server 104, mobile device 106, and data recorder 108 are interconnected by network 102. Network 102 can be any combination of connections and protocols capable of supporting communications between server 104, mobile device 106, data recorder 108, and insurance program 110. Network 102 may also be implemented as a number of different types of networks, such as an intranet, a local area network (LAN), a virtual local area network (VLAN), or a wide area network (WAN). FIG. 1 is intended as an example and not as an architectural limitation for the different embodiments.

In the exemplary embodiment, server 104 may be, for example, a server computer system such as a management server, a web server, or any other electronic device or computing system capable of sending and receiving data. In another embodiment, server 104 may be a data center, consisting of a collection of networks and servers providing an IT service, such as virtual servers and applications deployed on virtual servers, to an external party. In another embodiment, server 104 represents a “cloud” of computers interconnected by one or more networks, where server 104 is a computing system utilizing clustered computers and components to act as a single pool of seamless resources when accessed through network 102. This is a common implementation for data centers in addition to cloud computing applications. In the exemplary embodiment, server 104 includes an insurance program 112 and a database 114.

In the exemplary embodiment, insurance program 112 operates on a central server, such as server 104, and can be utilized by one or more mobile devices, such as mobile device 106, via a mobile application, such as insurance app 110, downloaded from the central server or a third-party application store, and installed and executed on mobile device 106. In another embodiment, insurance program 112 may be a software-based program, downloaded from a central server, such as server 104, and installed on one or more mobile devices, such as mobile device 106. In yet another embodiment, insurance program 112 may be utilized as a software service provided by a third-party cloud service provider (not shown).

In the exemplary embodiment, insurance program 112 is a software based program for generating real-time insurance premium alerts on a mobile device, such as mobile device 106. Insurance program 112 gathers insurance registration information and historical data about, for example, a driver, a vehicle, a route (e.g., various roads and conditions), and a weather forecast, etc., to generate an alert template utilized by insurance app 110 to generate real-time insurance premium alerts.

In the exemplary embodiment, database 114 is a conventional database for storing registration information and various data points related to vehicle insurance and generating insurance premium alerts. For example, database 114 may store historical information related to a driver, a vehicle, or a particular route, and registration information about a driver, a journey, a path, etc., as provided by insurance program 112.

In the exemplary embodiment, mobile device 106 is a client to server 104 and may be, for example, a tablet computer, a personal digital assistant (PDA), a smart phone, a thin client, or any other electronic device or computing system capable of sending and receiving data with server 104, data recorder 108, and insurance program 112 through network 102. For example, mobile device 106 may be a mobile device capable of connecting to a network, such as network 102 to access the Internet, register for insurance, and receive an alert template from a central server, such as server 104, for generating real-time insurance premium alerts. In one embodiment, mobile device 106 may be any suitable type of mobile device capable of running mobile applications, including a smart phone, tablet, slate, or any type of device that runs a mobile operating system. Mobile device 106 includes an insurance app 110 for generating real-time insurance premium alerts.

In an alternate embodiment, mobile device 106 may be any wearable electronic device, including wearable electronic devices affixed to eyeglasses and sunglasses, helmets, wristwatches, clothing, wigs, and the like, capable of sending, receiving, and processing data. For example, mobile device 106 may be a wearable electronic device, such as a wristwatch, capable of executing an application, monitoring various data points, and generating real time micro insurance alerts.

In the exemplary embodiment, insurance app 110 is a software-based program configured to generate real-time insurance premium alerts on a mobile device, such as mobile device 106. Insurance app 110 is a client-side mobile application that provides the capability to communicate with insurance program 112 on server 104 to register for vehicle insurance and receive an alert template. In the exemplary embodiment, insurance app 110 monitors various real-time data points, such as road/traffic conditions, vehicle information, and a current location of a driver/vehicle, etc., to determine whether to generate an insurance alert. For example, where a user deviates from a pre-specified route for a journey registered with insurance program 112, insurance app 110 utilizes an alert template to calculate a new premium (i.e., changed cost due to deviation) and send an insurance alert to the user as notification of the new premium. Insurance app 110 provides a user with the capability to configure alerts, modify insurance on-the-go, or cancel existing insurance from a mobile device, such as mobile device 106.

In the exemplary embodiment, data recorder 108 is any physical device used in telemetry, such as a black box, consisting of various sensors, recording devices, and control devices used to remotely measure vehicle data and driver behavior. Insurance app 110 communicates with data recorder 108 to monitor vehicle specific data and driver behavior (as inferred from vehicle specific data). Insurance app 110 gathers vehicle and driver information from data recorder 108 for use in determining whether to generate a real-time alert.

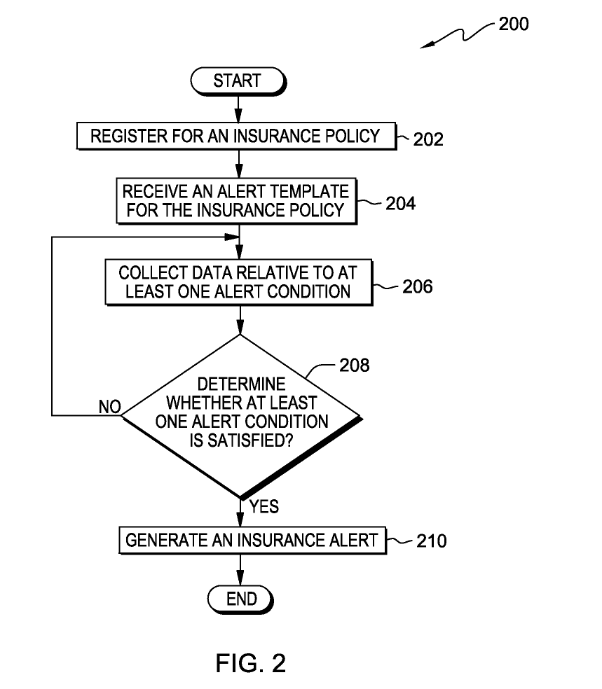

FIG. 2 depicts a flowchart of an exemplary process flow of insurance app 110, generally designated 200, for generating real-time insurance alerts, in accordance with an embodiment of the present invention.

Insurance app 110 registers for an insurance policy with insurance program 112 (202). In the exemplary embodiment, insurance app 110 registers for an insurance policy by prompting a user to provide one or more registration inputs including, without limitation, customer information, a user ID, vehicle information, a vehicle ID, an originating location, a destination, a desired route, and payment information, etc., on a mobile device, such as mobile device 106. Insurance app 110 sends registration information to insurance program 112 on server 104 to complete registration. For example, insurance app 110 may register for an insurance policy by prompting a driver to provide an originating location, such as Shanghai Road, Nanjing, a destination, such as No. 10 Jinyin Jie, Nanjing, and a desired route, such as via Longpan Road Y18, along with requisite customer and vehicle information as defined by an insurance provider. In one embodiment, insurance app 110 registers for an insurance policy by prompting a user to provide a type of user journey, such as a regular journey, a repeatable journey, or a custom (one-time) journey, wherein a journey is defined as a route from an originating location to an ending location. In the embodiment, a regular journey can be registered with pre-filled forms, and multiple journeys (e.g., scheduled, future, or repeatable journeys) can be registered at one time. In another embodiment, insurance app 110 may offer custom journeys (e.g., weekend getaways) at a promotional rate to a user for marketing purposes.

In response to registering for the insurance policy, insurance app 110 receives an alert template for the insurance policy (204). In the exemplary embodiment, insurance app 110 receives an alert template for the insurance policy from insurance program 112 on server 104. In the exemplary embodiment, insurance program 112 is a server side component responsible for generating an alert template for an insurance policy and a premium quote for the insurance policy. In the exemplary embodiment, the alert template includes at least one alert condition based, at least in part, on a plurality of real-time data points having potential to impact the insurance policy. For example, insurance app 110 may receive an alert template including a plurality of alert conditions relating to a vehicle's speed, an average gear change rate, a route deviation, an insurance delta for a desired route, a vehicle's engine temperature, a change in weather conditions, a traffic condition, and a time of day (e.g., peak time or weekend), etc. In one embodiment, an alert template can be encrypted, for example, using secure quick reliable login (SQRL) concepts. In the exemplary embodiment, at least one alert condition within the alert template is configured as a default alert threshold, wherein exceeding the default alert threshold impacts a quoted insurance policy (i.e., cost of insurance) by a pre-determined value (i.e., warrants an increase in an insurance premium of a pre-determined amount). In another embodiment, at least one alert threshold within the alert template may be user configurable, such that insurance app 110 prompts a user to optionally configure one or more additional alerts based on a user's preference for alerts not provided in the alert template. In one embodiment, insurance app 110 receives a premium quote (i.e., cost to the driver) for a requested insurance policy with the alert template from insurance program 112.

In response to receiving the alert template, insurance app 110 collects data relative to at least one alert condition (206). In the exemplary embodiment, insurance app 110 collects real-time data relative to the at least one alert condition included within the alert template to monitor any changes in the real-time data that impact at least one alert output associated with an alert threshold. In the exemplary embodiment, insurance app 110 collects the real-time data from a user's mobile device, such as mobile device 104 (i.e., global positioning system (GPS) data), a data recorder within a user's vehicle, such as data recorder 108 (i.e., vehicle and driver behavior related information), and a server, such as server 104 (i.e., static information, historical information, weather data, and traffic data). For example, insurance app 110 monitors a user's mobile device, such as mobile device 106, for location data provided by an integrated GPS, and collects data relative to the user's position that may potentially impact an alert output, such as a route deviation alert threshold. In another example, insurance app 110 monitors a vehicle's data recorder, such as data recorder 108, for vehicle information such as an engine temperature, an engine's revolutions per minute, and a vehicles speed, etc., and collects data that may potentially impact an alert output, such as a vehicle speed alert threshold. In one embodiment, insurance app 110 may collect a plurality of data relative to a user (e.g., a user's heart rate, a user's blood pressure, a user's previous driving record, and a user's age, etc.), a user's vehicle (e.g., a make, a model, a model year, and a color), a user's location (e.g., a GPS location), a weather forecast (e.g., an inclement weather alert, a ten day forecast, etc.,) a vehicle's speed, and a vehicle's temperature, etc., for use in determining whether at least one alert condition is satisfied.

Insurance app 110 determines whether at least one alert condition is satisfied (208). In the exemplary embodiment, insurance app 110 determines whether at least one alert condition is satisfied by comparing the real-time data collected against the at least one alert condition within the alert template. Insurance app 110 determines whether a difference between the real-time data is greater than a pre-defined data threshold associated with each alert condition. In the exemplary embodiment, insurance app 110 performs the aforementioned determination on a mobile device, such as mobile device 106, by utilizing the alert template provided by an insurance program on a server, such as insurance program 112 on server 104. For example, in the case of an alert condition related to a user's vehicle speed, insurance app 110 compares real-time data collected relative to the user's vehicle speed, such as a measurement of speed (e.g., miles per hour) against a pre-defined data threshold for a vehicle's speed alert condition in an alert template. In the above example, where real-time data indicates a user's current vehicle speed at 75 miles per hour, and a pre-defined data threshold for a vehicle's speed alert condition is 65 miles per hour, insurance app 110 determines that the vehicle's speed alert condition is satisfied. In one embodiment, in determining that a deviation of real-time data from pre-defined data threshold is greater than a certain deviation value, insurance app 110 determines that the alert condition is exceeded. For example, insurance app 110 may compare an actual total distance traveled by a user on a route that is different from an original route (i.e., specified when registering for an insurance policy) to the estimated total distance of the original route specified, and where the actual total distance traveled deviates by a certain deviation value, such as 20 miles, from a pre-defined data threshold for a distance traveled alert threshold, insurance app 110 determines that the distance traveled alert threshold is exceeded.

In response to determining that at least one alert condition is satisfied (YES branch, 208), insurance app 110 generates an insurance alert (210). In the exemplary embodiment, insurance app 110 generates an insurance alert by using a predictive model to calculate a differential of insurance cost based, at least in part, on each alert condition satisfied. In the exemplary embodiment, insurance app 110 generates the insurance alert on a mobile device, such as mobile device 106, in real-time, without the need to communicate with a server, such as server 104. In one embodiment, insurance app 110 generates an insurance alert by dividing an insurance premium quote for an insurance policy into a fixed cost and a variable cost, wherein the variable cost is further divided in segments based, at least in part, on a plurality of real-time data collected at the mobile device. For example, insurance app 110 may further divide a variable cost into a plurality of levels based on a user specified route (i.e., a route specified when registering for an insurance policy), wherein a deviation from the user specified route (i.e., a change in path) invokes one or more levels of variable cost relative to a level of deviation from the user specified route. Insurance app 110 generates an insurance alert reflective of the differential of insurance cost for the deviation to inform a user when an insurance cost is likely to increase based on at least one alert condition being satisfied.

In response to determining that an alert condition has not been satisfied (NO branch, 208), insurance app 110 continues to collect data relative to the at least one alert condition (206). In the exemplary embodiment, insurance app 110 continuously monitors and collects data relative to the at least one alert condition for a defined period of time, such as a time needed to complete a trip, anytime from when a user's vehicle is started until it is turned off, and anytime from when a user executes insurance app 110, etc.

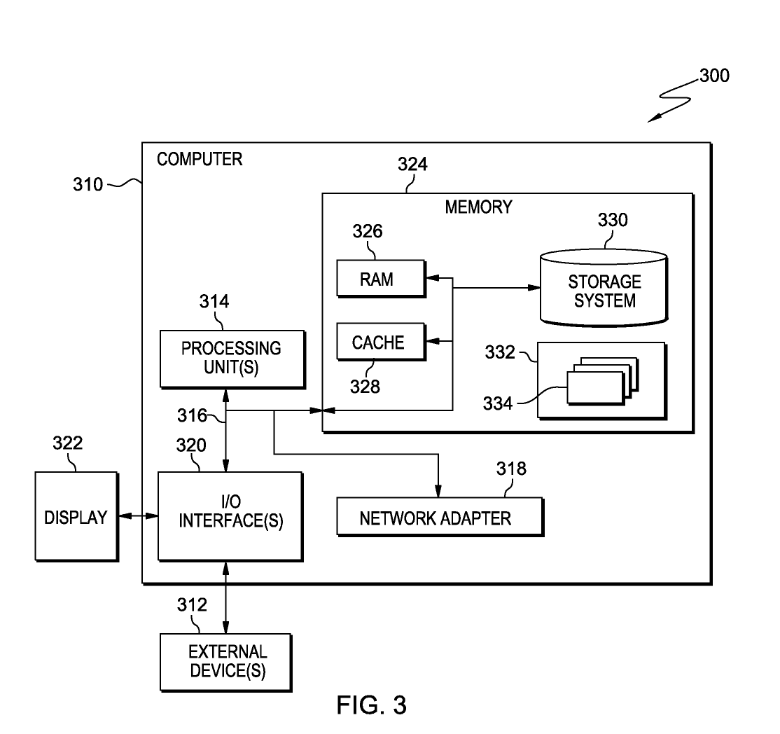

FIG. 3 is a block diagram, generally designated 300, depicting components of a data processing system (such as mobile device 106 of data processing environment 100), in accordance with an embodiment of the present invention. It should be appreciated that FIG. 3 provides only an illustration of one implementation and does not imply any limitations with regard to the environments in that different embodiments can be implemented. Many modifications to the depicted environment can be made.

In the illustrative embodiment, mobile device 106 in data processing environment 100 is shown in the form of a general-purpose computing device. The components of computer system 310 can include, but are not limited to, one or more processors or processing unit 314, memory 324, and bus 316 that couples various system components including memory 324 to processing unit(s) 314.

Bus 316 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer system 310 typically includes a variety of computer system readable media. Such media can be any available media that is accessible by computer system 310, and it includes both volatile and non-volatile media, removable and non-removable media.

Memory 324 can include computer system readable media in the form of volatile memory, such as random access memory (RAM) 326 and/or cache memory 328. Computer system 310 can further include other removable/non-removable, volatile/non-volatile computer system storage media. By way of example only, storage system 330 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM, or other optical media can be provided. In such instances, each can be connected to bus 316 by one or more data media interfaces. As will be further depicted and described below, memory 324 can include at least one computer program product having a set (e.g., at least one) of program modules that are configured to carry out the functions of embodiments of the invention.

Program/utility 332, having one or more sets of program modules 334, can be stored in memory 324 by way of example, and not limitation, as well as an operating system, one or more application programs, other program modules, and program data. Each of the operating systems, one or more application programs, other program modules, and program data, or some combination thereof, can include an implementation of a networking environment. Program modules 334 generally carry out the functions and/or methodologies of embodiments of the invention as described herein. Computer system 310 can also communicate with one or more external devices 312 such as a keyboard, a pointing device, a display 322, etc., or one or more devices that enable a user to interact with computer system 310 and any devices (e.g., network card, modem, etc.) that enable computer system 310 to communicate with one or more other computing devices. Such communication can occur via Input/Output (I/O) interface(s) 320. Still yet, computer system 310 can communicate with one or more networks such as a local area network (LAN), a general wide area network (WAN), and/or a public network (e.g., the Internet) via network adapter 318. As depicted, network adapter 318 communicates with the other components of computer system 310 via bus 316. It should be understood that although not shown, other hardware and software components, such as microcode, device drivers, redundant processing units, external disk drive arrays, RAID systems, tape drives, and data archival storage systems can be used in conjunction with computer system 310.

The present invention may be a system, a method, and/or a computer program product. The computer program product may include a computer readable storage medium (or media) having computer readable program instructions thereon for causing a processor to carry out aspects of the present invention.

The computer readable storage medium can be any tangible device that can retain and store instructions for use by an instruction execution device. The computer readable storage medium can be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network can comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention can be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions can execute entirely on the user's computer, partly on the user's computer, as a stand-alone software package, partly on the user's computer and partly on a remote computer or entirely on the remote computer or server. In the latter scenario, the remote computer can be connected to the user's computer through any type of network, including a local area network (LAN) or a wide area network (WAN), or the connection can be made to an external computer (for example, through the Internet using an Internet Service Provider). In some embodiments, electronic circuitry including, for example, programmable logic circuitry, field-programmable gate arrays (FPGA), or programmable logic arrays (PLA) can execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions can be provided to a processor of a general purpose computer, a special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions can also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions can also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams can represent a module, segment, or portion of instructions, which comprises one or more executable instructions for implementing the specified logical function(s). In some alternative implementations, the functions noted in the block can occur out of the order noted in the Figures. For example, two blocks shown in succession can, in fact, be executed substantially concurrently, or the blocks can sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

The terminology used herein is for the purpose of describing particular embodiments only and is not intended to be limiting of the invention. It should be appreciated that any particular nomenclature herein is used merely for convenience and thus, the invention should not be limited to use solely in any specific function identified and/or implied by such nomenclature. Furthermore, as used herein, the singular forms of “a”, “an”, and “the” are intended to include the plural forms as well, unless the context clearly indicates otherwise.

What is claimed is:

1. A method for generating real-time insurance alerts, the method comprising:
registering, by a first computer processor, for an insurance policy;
receiving, by the first computer processor, an alert template for the insurance policy, wherein the alert template includes at least one alert condition;
collecting, by one or more computer processors, data relative to the at least one alert condition; and
determining, by the first computer processor, whether the at least one alert condition is satisfied.

2. The method of claim 1, wherein registering for an insurance policy, further comprises prompting, by the first computer processor, to provide one or more registration inputs including, but not limited to:
customer information;
a user ID;
vehicle information;
a vehicle ID;
an originating location;
a destination;
a desired route; and
payment information.

3. The method of claim 1, wherein receiving an alert template for the insurance policy, further comprises generating, by a second computer processor, the alert template on a server side component, wherein the alert template includes at least one alert condition based, at least in part, on a plurality of real-time data points having potential to impact the insurance policy.

4. The method of claim 1, wherein collecting data relative to the at least one alert condition, further comprises monitoring, by the first computer processor, real-time data from one or more of:
a user's mobile device;
a data recorder within a user's vehicle; and
a server associated with the insurance policy.

5. The method of claim 1, wherein determining whether the at least one alert condition is satisfied, further comprises comparing, by the first computer processor, the real-time data collected against the at least one alert condition within the alert template, wherein comparing the real-time data against the at least one alert condition within the alert template includes determining whether a difference between the real-time data is greater than a pre-defined data threshold associated with each alert condition.

6. The method of claim 5, further comprises responsive to determining that an alert condition has not been satisfied, collecting, by the first computer processor, data relative to the at least one alert condition, wherein collecting the data includes monitoring data relative to the at least one alert condition for a defined period of time.

7. The method of claim 1, further comprises responsive to determining the at least one alert condition is satisfied, generating, by the first computer processor, an insurance alert.

8. The method of claim 7, wherein generating an insurance alert, further comprises utilizing, by a first computer processor, a predictive model to calculate a differential of insurance cost based, at least in part, on each alert condition satisfied.

9. The method of claim 1, wherein the first computer processor is a mobile device.

10. A computer program product for generating real-time insurance, the computer program product comprising:
one or more computer readable storage media and program instructions stored on the one or more computer readable storage media, the program instructions comprising:
program instructions to register, by a first computer processor, for an insurance policy;
program instructions to receive, by the first computer processor, an alert template for the insurance policy, wherein the alert template includes at least one alert condition;
program instructions to collect, by one or more computer processors, data relative to the at least one alert condition; and
program instructions to determine, by the first computer processor, whether the at least one alert condition is satisfied.

11. The computer program product of claim 10, wherein program instructions to register for an insurance policy, further comprises program instructions to prompt, by the first computer processor, to provide one or more registration inputs including, but not limited to:
customer information;
a user ID;
vehicle information;
a vehicle ID;
an originating location;
a destination;
a desired route; and
payment information.

12. The computer program product of claim 10, wherein program instructions to receive an alert template for the insurance policy, further comprises program instructions to generate, by a second computer processor, the alert template on a server side component, wherein the alert template includes at least one alert condition based, at least in part, on a plurality of real-time data points having potential to impact the insurance policy.

13. The computer program product of claim 10, wherein program instructions to collect data relative to the at least one alert condition, further comprises program instructions to monitor, by the first computer processor, real-time data from one or more of:
a user's mobile device;
a data recorder within a user's vehicle; and
a server associated with the insurance policy.

14. The computer program product of claim 10, wherein program instructions to determine whether the at least one alert condition is satisfied, further comprises program instructions to compare, by the first computer processor, the real-time data collected against the at least one alert condition within the alert template, wherein comparing the real-time data against the at least one alert condition within the alert template includes determining whether a difference between the real-time data is greater than a pre-defined data threshold associated with each alert condition.

15. The computer program product of claim 14, further comprises, responsive to determining that an alert condition has not been satisfied, program instructions to collect, by the first computer processor, data relative to the at least one alert condition, wherein collecting the data includes monitoring data relative to the at least one alert condition for a defined period of time.

16. The computer program product of claim 10, further comprises, responsive to determining the at least one alert condition is satisfied, program instructions to generate, by the first computer processor, an insurance alert.

17. The computer program product of claim 16, wherein program instructions to generate an insurance alert, further comprises program instructions to utilize, by a first computer processor, a predictive model to calculate a differential of insurance cost based, at least in part, on each alert condition satisfied.

18. The computer program product of claim 10, wherein the first computer processor is a mobile device.

19. A computer system for generating real-time insurance alerts, the computer program product comprising:
one or more computer readable storage media;
program instructions stored on at least one of the one or more computer readable storage media for execution by at least one of the one or more computer processors, the program instructions comprising:
program instructions to register, by a first computer processor, for an insurance policy;
program instructions to receive, by the first computer processor, an alert template for the insurance policy, wherein the alert template includes at least one alert condition;
program instructions to collect, by one or more computer processors, data relative to the at least one alert condition; and
program instructions to determine, by the first computer processor, whether the at least one alert condition is satisfied.

20. The computer system of claim 19, wherein the first computer processor is a mobile device.
